(19) United States
(12) Patent Application Publication
(10) Pub. No.: US 2005/0114792 A1
(43) Pub. Date: May 26, 2005

(54) Method and system for exchanging information with a process using a window display port

(76) Inventor: Stephen B. Gest, Ft. Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/720,256

(22) Filed: Nov. 25, 2003

(51) Int. Cl. G06F 3/00; H04N 5/445

(52) U.S. Cl. 715/804; 715/805; 715/748; 715/781; 715/751; 715/759; 348/564

(57) ABSTRACT

A method and system are described for exchanging information with a process using a window display port. According to an exemplary embodiment, information related to a first process is presented in a window that is resizable within a presentation space of a monitor. A second process is selected and a display port is opened in a portion of the window. Information related to the second process is presented in the display port. The display port is linked to the window within the presentation space of the monitor. The first and second processes can be associated with respective application programs.

### BACKGROUND

Persons using today's desktop technology are faced with the challenge of efficiently managing large amounts of information that can be presented while interacting with windowing applications and desktop displays. For example, viewing multiple pages on the World Wide Web (or web) simultaneously can involve a user launching a corresponding number of web browser applications (or browser windows) in separate windows on the desktop. As the number of launched browser windows increases, the challenge in managing those windows within the desktop area can increase significantly.

Users can perform windowing operations, such as shuffling, closing, re-opening. and hiding windows, to locate a window of particular interest within the desktop. Moreover, it can be useful to place separate windows, having related information, in close proximity to one another on the desktop. Users can also launch applications in a particular sequence, or to perform windowing operations to place the windows in the desired locations, and can rearrange the windows if a window including related information is to be repositioned within the desktop.

Some web browser applications allow multiple “virtual web pages” to be accessed simultaneously, but not necessarily to be viewed simultaneously. Users can scroll through these virtual web pages to view information of particular interest. Multiple displays and/or computer systems can be used to simultaneous view large amounts of information presented in multiple windows. Switch boxes can be used with these systems to allow the multiple computer systems to share a common display, or to interface with the multiple displays. U.S. Pat. No. 6,373,500 to Daniels describes an apparatus for simultaneously displaying the output of two or more computers on a single monitor in a manner similar to the manner in which television sets provide picture-in-picture (PIP) viewing.

### SUMMARY

Accordingly, a method and system are disclosed for exchanging information with a process using a window display port. According to an exemplary embodiment, information related to a first process is presented in a window that is resizable within a presentation space of a monitor. A second process is selected and a display port is opened in a portion of the window. Information related to the second process is presented in the display port. The display port is linked to the window within the presentation space of the monitor.

According to another exemplary embodiment, a system is described for exchanging information with a process using a window display port. The system includes a monitor having a presentation space, and a processor operatively coupled to the monitor. The processor includes logic configured to present information related to a first process in a window that is resizable within a presentation space of a monitor. Logic configured to select a second process is included in the processor. The processor includes logic configured to open a display port in a portion of the window. Additional logic configured to present information related to the second process in the display port is included in the processor. The processor also includes logic configured to link the display port to the window within the presentation space of the monitor.

### BRIEF DESCRIPTION OF THE DRAWINGS

The accompanying drawings provide visual representations which will be used to more fully describe the representative embodiments disclosed here and can be used by those skilled in the art to better understand them and their inherent advantages. In these drawings, like reference numerals identify corresponding elements, and:

FIG. 1 illustrates a system for exchanging information with a process using a window display port, according to an exemplary embodiment;

FIG. 2 illustrates a selecting of the process, according to exemplary embodiments;

FIG. 3 illustrates a swapping of information presented in the display port with information presented in a window including the display port, according to exemplary embodiments;

FIG. 4 illustrates a hiding and a closing of the display port, according to exemplary embodiments;

FIG. 5 illustrates an opening of a second window including information formerly presented in the display port, according to an exemplary embodiment; and

FIG. 6is a flowchart illustrating a method for exchanging information with a process using a window display port, according to an exemplary embodiment.

### DETAILED DESCRIPTION

Various aspects will now be described in connection with exemplary embodiments, including certain aspects described in terms of sequences of actions that can be performed by elements of a computer system. For example, it will be recognized that in each of the embodiments, the various actions can be performed by specialized circuits or circuitry (e.g., discrete and/or integrated logic gates interconnected to perform a specialized function), by program instructions being executed by one or more processors, or by a combination of both.

Thus, the various aspects can be embodied in many different forms, and all such forms are contemplated to be within the scope of what is described. For each of the various aspects, any such form of embodiment can be referred to here as “logic configured to” perform, or “logic that” performs a described action.

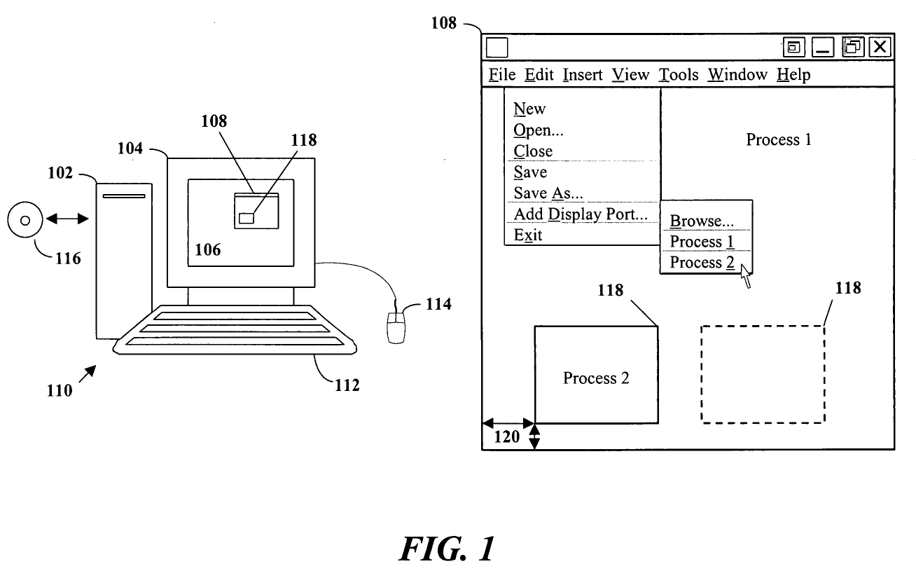

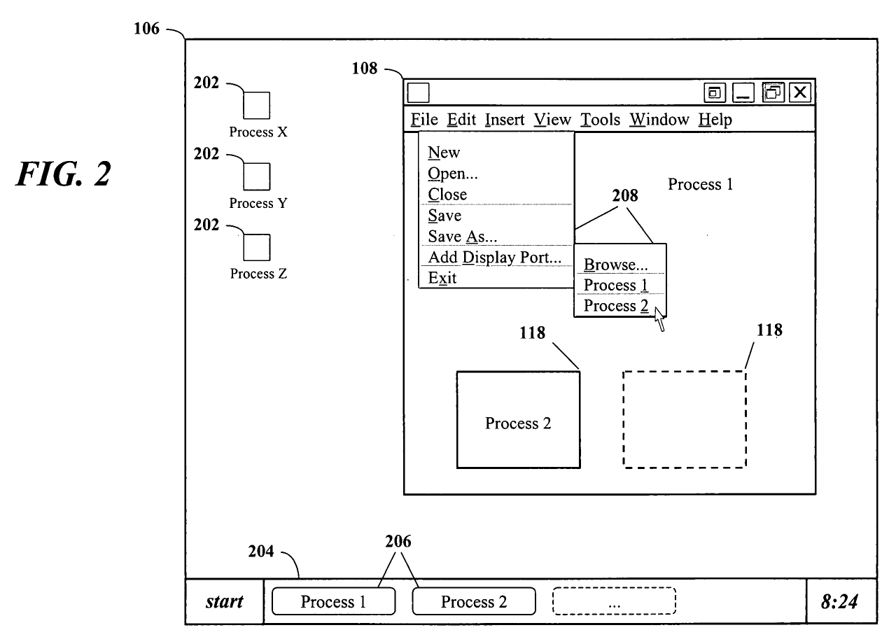

A system for exchanging information with a process using a window display port according to an exemplary embodiment is shown in FIG. 1. The system includes a processor 102 and a monitor 104, as shown in the figure. The monitor 104 includes a presentation space 106. The presentation space 106 generally represents an entire viewable portion of the monitor 104 in which information, such as that included in the window 108, can be presented to a user. For example, FIG. 2 shows an exemplary presentation space 106 including a “desktop” view used by an operating system (OS) to exchange information with a user. The desktop view included in the presentation space 106 includes the resizable window 108, icons 202 used to launch processes, e.g., that can be executable on the processor 102, and a task pane 204 including task icons 206, among other things.

The processor 102 is operatively coupled to the monitor 104. For example, the processor 102 can be included in a personal computer (PC) 110 that can also include the monitor 104 and a user interface. The user interface can include a keyboard 112 and a pointing device 114 (such as the mouse shown), operatively coupled to the processor 102, for providing information to processes (e.g., “Process 1” and “Process 2”). The processes can be executed on the processor 102. Output from the processes can be displayed on the presentation space 106 of the monitor 104, e.g., in the window 108 shown.

The system includes means for presenting information related to a first process in a window that is resizable within a presentation space of a monitor, such as the processor 102, which includes logic configured to present information related to the first process in the resizable window. For example, FIG. 2 illustrates a window 108 that can be resized within the presentation space 106 of the monitor 104. Information related to the first process, e.g., “Process 1”, can be displayed in the window 108. Techniques for presenting process information in a window that is resizable within the presentation space of a monitor are well known to those skilled in the arts of OS, software, and PC hardware design, and consequently are not described in detail here.

The first process “Process 1” can be an application program, such as a word processor or an email program, or can be a process included in such an application program. The first process “Process 1” can be executed on the processor 102, or can be executed on a different processor (not shown) in a multi-processor environment, or perhaps on a different processor (not shown) remotely connected to the processor 102. Program instructions for executing the first process “Process 1” on the processor 102 can be stored in memory (not shown) coupled to the processor 102, or can be stored on external media, such as the removable storage device 116 shown.

The system also includes means for selecting a second process, such as the processor 102, which includes logic configured to select the second process. The second process, e.g., “Process 2”, like the first process “Process 1”, can be an application program, such as a word processor or an email program, or can be a process included in such an application program. The second process “Process 2” can be executed on the same processor 102 as the first process “Process 1”, or can be executed on a different processor (not shown), perhaps remotely connected to the processor 102. Program instructions for executing the second process “Process 2” on the processor 102 can be stored in memory (not shown) coupled to the processor 102, or can be stored on external media, such as the removable storage device 116.

According to an exemplary embodiment, the processor 102 can include logic configured to add the second process to a list of selected processes. Additional logic configured to include the list of selected processes as selectable entries in a drop-down menu associated with the window can be included in the processor 102. For example, FIG. 2 shows a drop-down menu 208 associated with a window menu command “File” that can, in turn, be associated with the window 108. The drop-down menu 208 can include an entry, e.g., “Add Display Port”, that can be selected by a user in a known manner, e.g., using the pointing device 114. The means for selecting the second process can include the additional logic included in the processor 102 forming the drop-down menu, and the pointing device 114. Selecting the entry “Add Display Port” can result in a “cascaded” portion of the drop-down menu 208 to be presented in the window 108. The cascaded portion of the drop-down menu 208 can include the list of selected processes as selectable entries in the menu, e.g., “Process 1”, “Process 2”, etc., as shown.

The logic configured to select can include logic configured to browse a repository of available processes including the second process. The logic configured to browse can be responsive to a selecting of an entry in the drop-down menu. For example, the cascaded portion of the drop-down menu 208 shown in FIG. 2 includes an entry “Browse . . . ” that, when selected, can cause a dialog box (not shown) to be presented to a user facilitating the selection of the second process “Process 2” from the available processes included in the repository.

The system also includes means for opening a display port in a portion of the window, such as the processor 102, which includes logic configured to open the display port in the window portion. As used here, a “display port” can include any portion of the presentation space 106 that can used by a process, e.g., the second process “Process 2”, to exchange information with a user. The exchange of information can occur, e.g., by the process presenting output information in the display port, and by directing input from a user interface to the processes presenting output information in the display port. For example, FIG. 1 shows a display port 118 open in a portion of the window 108. Input to the second process “Process 2” can be provided by the user interface including keyboard 112 and pointing device 114. The portion of the window 108 in which the display port 118 is open is “cropped” (or blocked) by the display port 118. Any number of display ports 118 (e.g., see additional display port 118 shown in dashed lines) can be opened in respective portions of the window 108.

Techniques for opening a display port in a portion of window are known to those skilled in the arts of OS, software, and PC hardware design. Methods such as MOTIF for UNIX OS platforms and WINDOWS for windows-based OS platforms can provide this capability. Using these methods, windows can be setup, input can be directed and received from the window, and output can be displayed in the window. Exemplary MICROSOFT WINDOWS code for creating a window, displaying the window, and processing events, such as keyboard input and mouse movements/clicks, follows.

// Exemplary WINDOWS code for opening a window called “Demo” and
// performing operations on the window.

hWnd = CreateWindow(“Demo”,

szAppName,
WS_OVERLAPPEDWINDOW,
CW_USEDEFAULT,
CW_USEDEFAULT,
CW_USEDEFAULT,
CW_USEDEFAULT,
NULL,
NULL,
hInstance,
NULL);

if (!hWnd)

return (0);

ShowWindow(hWnd, nCmdShow);
UpdateWindow(hWnd);
while (GetMessage(&msg, NULL, 0, 0)) {

TranslateMessage(&msg);
DispatchMessage(&msg);

}

The system also includes means for presenting information related to the second process in the display port, such as the processor 102, which includes logic configured to present information related to the second process in the display port. For example, output information from the second process “Process 2” can be presented in the display port 118. A user can monitor the information presented in the display port 118, related to the second process “Process 2”, at the same time the information related to the first process “Process 1” is presented in the window 108. Again, techniques for presenting process information in a display port are well known and are not described in detail here.

The system also includes means for linking the display port to the window within the presentation space of the monitor, such as the processor 102, which also includes logic configured to link the display port to the window within the presentation space of the monitor. As used here, to “link” or “linking” can include the formation of logical and/or physical relationships between the display port 118 and the window 108, such that the entities 118, 108 can be “tied” to one another within the presentation space 106. For example, linking means such as identifiers (e.g., numerical, string, etc.) of the display port 118 and window 108 can be assigned and associated with one another within the processor 102, and/or memory (not shown) coupled to the processor 102, to logically link the display port 118 to the window 108. The logical relationship can be used to physically link the display port 118 and window 108 to one another within the presentation space 106 of the monitor 104.

The logic configured to link can include additional logic configured to resize the display port an amount proportional to an amount the window changes when the window is resized. For example, if a user were to make the window 108, shown in FIG. 1, twenty percent larger, e.g., using the pointing device 114 in a known manner, the logic configured to resize can increase the size of the display port 118 a proportional amount of twenty percent. The system can also include means for maintaining a relative positioning of the display within the window, such as logic, included in the processor 102, configured to maintain a relative positioning of the display port within the window when repositioning the window within the presentation space of the monitor. For example, if a user were to move the window 108 within the presentation space 106, e.g., using the pointing device 114 in a known manner, the logic can maintain the relative positioning of the display port 118 within the window 108 as indicated by the arrows 120.

According to an exemplary embodiment, the system can include means for associating an input focus with the window, such as the processor 102, which can include logic configured to associate the input focus with the window, wherein the first process can receive information from means, such as a user interface, operatively coupled to the processor 102. The user interface can include input focus association means, such as the keyboard 112 and the pointing device 114 shown in FIG. 1. “Input focus” is used here to describe a capability to receive information gathered from the user interface. Typically, the input focus can be associated with a window, such as the window 108 shown in FIG. 1, although the input focus can be associated with other objects included in the presentation space 106, such as the display port 118 or objects in the task pane 204 shown in FIG. 2. When the input focus is associated with an object included in the presentation space 106, the process having information presented in the object can receive input information from the user interface.

For example, in FIG. 1, the first process “Process 1”, having information presented in the window 108, can be an email program. Output information from the email program, such as the text of a message, can be presented in the window 108. The input focus can be associated with the window 108, such that the email program can receive input information, e.g., an instruction to delete the message, from the keyboard 112. Similarly, the input focus can be associated with the display port 118, wherein the second process “Process 2” can receive information from the user interface.

According to an exemplary embodiment, the processor 102 can include logic configured to associate the input focus with only one of the window and the display port at a time. For example, in FIG. 1 only one of the window 108 and the display port 118 can be associated with the input focus. As such, only one of the first process “Process 1” and the second process “Process 2” can receive information from the user interface. Output information from the process having information presented in the window 108 or display port 118 not associated with the input focus can continue to be presented in the respective window or display port.

In a related exemplary embodiment, the processor 102 can also include logic configured to switch the input focus between the window and the display port. Accordingly, output information from the process having information presented in the window 108 or display port 118 previously associated with the input focus can continue to be presented in the respective window or display port, but the process can no longer receive information from the user interface after switching the input focus. The processor 102 can also include logic configured to switch the input focus to the display port when opening the display port in the portion of the window. For example, a user can select the second process “Process 2” from the drop-down menu 208 shown in FIG. 2, while the input focus can be associated with the window 108. The display port 118 can then be opened to present information related to the second process “Process 2”. The input focus can be automatically switched to the display port 118 when opened, such that the second process “Process 2” can receive information from the user interface.

In yet another exemplary embodiment, the system can include means for swapping information, such as the processor 102, which can include logic configured to swap the information presented in the display port related to the second process with the information presented in the window related to the first process. The processor 102 can include additional logic configured to associate an input focus with the window when swapping the information presented in the display port with the information presented in the window, wherein the second process can receive information from a user interface. The logic configured to swap the information can be responsive to means, such as an output of a pointing device included in the user interface.

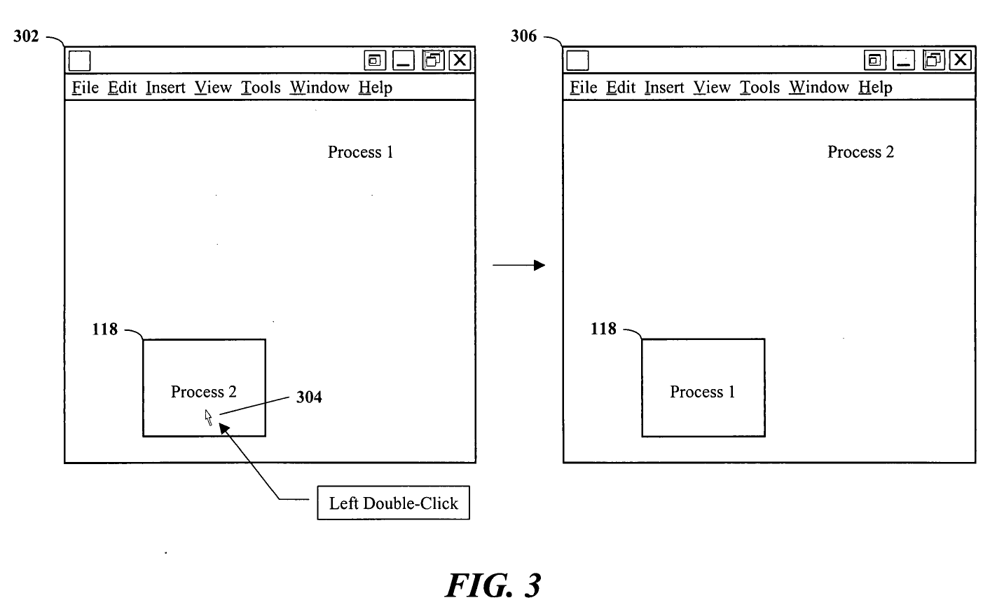

For example, FIG. 3 shows a sizeable window 302. Information related to a first process “Process 1” can be presented in the window 302. A display port 118 for presenting information related to a second process “Process 2” can be included in the window 302. A user can direct a pointer 304 over a display port 118 using a pointing device, such as the mouse 114 shown in FIG. 1. The user can then perform an action with the pointing device 114, such as “double-clicking”, which can cause the pointing device 114 to generate an output signal. The generated output signal can be used by the logic included in the processor 102 to exchange the information presented in the display port 118 related to the second process “Process 2” with the information presented in the window 302 related to the first process “Process 1”. The result can be the modified sizeable window 306 shown in FIG. 3, which depicts a state of the window 302 after the information presented in the display port 118 has been swapped with the information presented in the window 302.

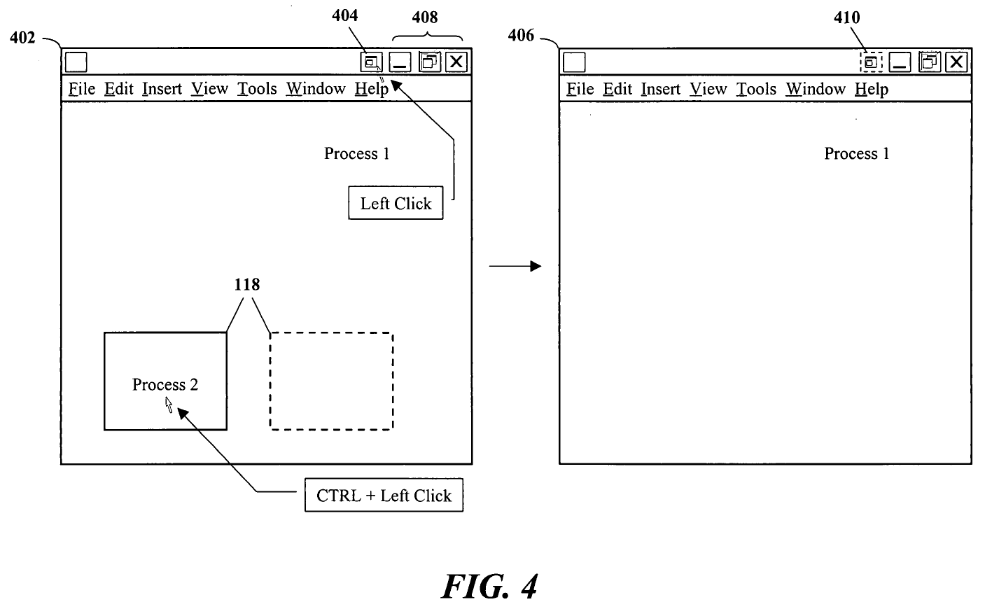

The system can also include means for hiding the presenting of information related to the second process, such as the processor 102, which can also include logic configured to hide the presenting of information related to the second process and the display port while maintaining an execution of the second process. The logic configured to hide can be responsive to an activation of a control button associated with the window. For example, FIG. 4 shows a sizeable window 402. Again, information related to a first process “Process 1” can be presented in the window 402, and information related to a second process “Process 2” can be presented in a display port 118 included in the window 402. Additional display ports (e.g., indicated by the dashed object) can be used to present information associated with other processes.

The window 402 can include a control button 404 that can be arranged in an area of the window 402 that includes other buttons 408 that can be used to invoke windowing operations for altering an appearance of the window 402 (e.g., minimize, restore, and close operations, as shown). The control button 404 can be presented in an inactive state, e.g., the “grayed-out” control button 410, to indicate that no display ports 118 are currently active-hidden or otherwise-in the window (discussed in greater detail below). A user can activate the control button 404, e.g., by “left-clicking” on the button using the pointing device 114 shown in FIG. 1.

Activation of the control button 404 can be used by the logic to hide the presenting of information related to the second process “Process 2” and the respective display port 118 included in the window 402. The result can be the modified sizeable window 406 shown in FIG. 4, which depicts a state of the window 402 after the information presented in the display port 118 and the display port 118 itself have been hidden. Activation of the control button 404 can result in one or more (e.g., all) of the display ports 118 included in the window 108 to be hidden. According to the exemplary embodiment, an execution of the second process “Process 2” is maintained while hiding the display port 118. An activation of the control button 404 a second time, while the display port 118 is being hidden, can be used by the logic to re-open the display port 118 and to re-present the information related to the second process “Process 2” in the display port 118.

The logic configured to hide can also be responsive to a hiding of the presenting of information related to the first process and the window while maintaining an execution of the first process. For example, a user can hide the window 402 (and the information presented in the window 402 related to the first process “Process 1”) using the minimize “−” control button 408 included in the window 402). The hiding of the window 402 can be used by the logic to automatically hide the presenting of information related to the second process “Process 2” and the respective display port 118 included in the window 402. The minimized window 402 and hidden display port 118 can be accessed by activating an appropriate task pane icon 206 included in the task pane 204 shown in FIG. 2. For example, a user can position a pointer over the appropriate task pane icon 206 using the pointing device 114, and can then perform an operation, such as “double-clicking”. Additional logic included in the processor 102 can re-open the window 402 and the display port 118, and can re-present the information related to the first and second processes.

According to another exemplary embodiment, the processor can include logic configured to close the display port and halt an execution of the second process. For example, a user can position a pointer over the display port 118 included in the window 402 and perform an action, such as pressing a “CTRL” key on the keyboard 112 while “single-clicking” a left button of the pointing device 114. The result can be the modified sizeable window 406 shown in FIG. 4, which depicts a state of the window 402 after the display port 118 has been closed and an execution of the second process “Process 2” has been halted. Note in the figure that the “grayed-out” control button 410 can be presented in the window 406 to indicate that the display port 118 is closed (in contrast to being hidden), and that no other display ports 118 are currently active (hidden or otherwise) in the window 406.

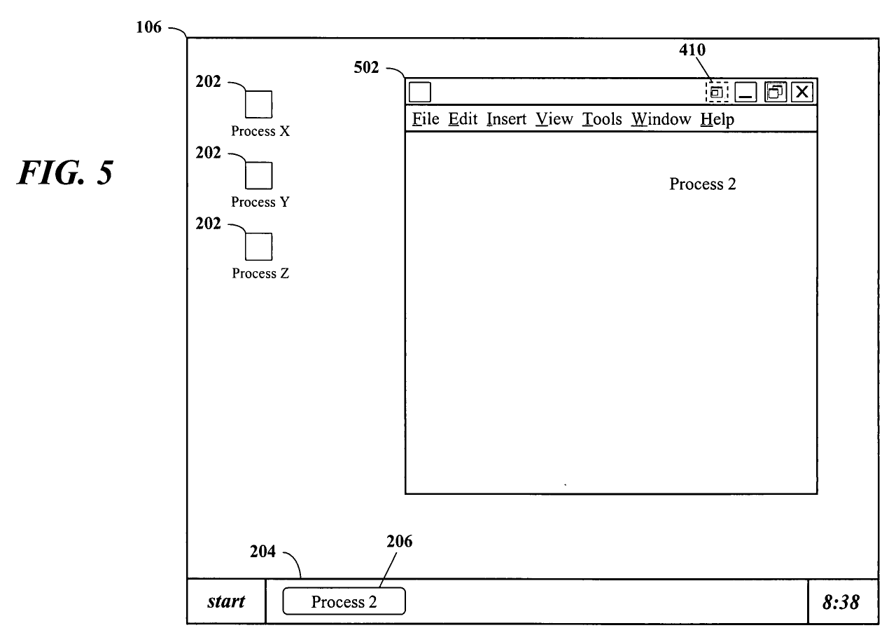

According to another exemplary embodiment, the processor 102 can also include logic configured to close the display port while maintaining an execution of the second process. In contrast to hiding the display port 118, as shown in FIG. 4, the display port can be closed while maintaining an execution of the second process “Process 2”. Additional logic configured to open a second window, e.g. the window 502 shown in FIG. 5, that is resizable within the presentation space 106 of the monitor 104 can be included in the processor 102. Logic configured to present information related to the second process “Process 2” in the second window 502 can also be included in the processor 102.

According to a related embodiment, the logic configured to close the display port can be responsive to a closing of the window and a halting of an execution of the first process. For example, a user can close the window 402 shown in FIG. 4, which includes the display port 118, using the close “X” control button 408 included in the window 402. While the closing of a window generally results in the halting of all processes being presented in that window, a user can desire that the execution of the second process “Process 2”, having information presented in the display port 118, continue after the window 402 is closed.

Accordingly, the closing of the window 402 can be used by the logic included in the processor to automatically: close the display port 118, open a second window 502 that is resizable within the presentation space 106 of the monitor 104, and then present information related to the second process “Process 2” in the second window 502. For example, FIG. 5 shows an exemplary desktop view 106 including a second window 502 that can be used to present information associated with the second process “Process 2” after the display port 118 is closed. Note in the exemplary desktop view 106 shown in FIG. 5 that the task pane icon 206 identifying the first process “Process 1” has been removed from the task pane 204 (as compared to that shown in FIG. 2) to reflect the closing of the window 404 and the halting of the first process “Process 1”. The task pane icon 206 identifying the second process “Process 2” remains in the task pane 204, and can be used to access the second window 502, e.g., using the pointing device 114. Additional sizeable windows can be opened and appropriate actions taken by the logic if more than one display port 118 is included in the window 402 being closed. Corresponding task pane icons 206 can be included in the task pane 204 for the added windows.

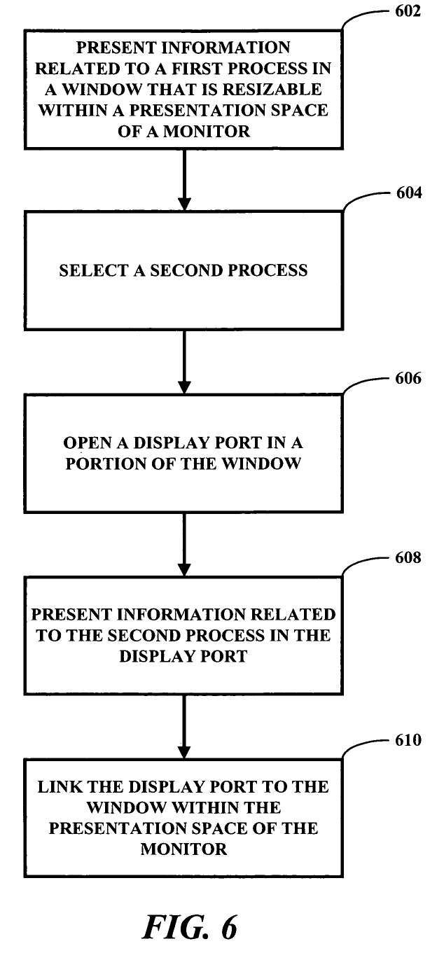

FIG. 6 depicts a flowchart illustrating an exemplary method for exchanging information with a process using a window display port. The method can be carried out using the exemplary system depicted in FIG. 1, portions of which are referenced below for illustration purposes.

In block 602, information related to a first process is presented in a window that is resizable within a presentation space of a monitor. For example, the first process can be the process “Process 1” presented in the window 108 included in the presentation space 106 of the monitor 104 shown in FIG. 1. In block 604, a second process is selected. The selection of the second process can occur as described above in conjunction with FIG. 2, which illustrates the selection of a second process “Process 2”. As described above, the first and second processes can be associated with respective application programs, or can be portions thereof.

In block 606, a display port can be opened in a portion of the window. For example, the display port 118 can be opened in the portion of the window 108 shown in FIG. 2 as described in detail above. In block 608, information related to the second process is presented in the display port. Referring again to FIG. 2, information related to the second process “Process 2” can be presented in the display port 118 as described above.

In block 610, the display port is linked to the window within the presentation space of the monitor. For example, FIG. 2 shows a display port 118 linked to the window 108 within the presentation space 106 of the monitor 104. As described above, the display port 118 and window 108 can be logically and/or physically linked to one another within the presentation space 106. The linking can include resizing the display port an amount proportional to an amount the window changes when the window is resized. The linking can also include maintaining a relative positioning of the display port within the window, such as that depicted by the arrows 120 in FIG. 1, when repositioning the window within the presentation space of the monitor.

According to an exemplary embodiment, an input focus can be associated with the window, wherein the first process can receive information from a user interface. The input focus can also be associated with the display port, wherein the second process can receive information from the user interface. The phrase “input focus” has the meaning described above in conjunction with the exemplary system shown in FIG. 1.

In a related embodiment, the input focus can be associated with only one of the window and the display port at a time. The input focus can further be switched between the window and the display port. For example, the input focus can be switched to the display port 118 when opening the display port 118 in the portion of the window 108, as described in conjunction with FIG. 1 above.

In another exemplary embodiment, the information presented in the display port related to the second process can be swapped with the information presented in the window related to the first process. FIG. 3 illustrates a swapping of the information presented in the display port 118 with information presented in the window 302 using the system shown in FIG. 1. As described above, a user can initiate the swapping using a pointing device, such as the mouse 114. For example, the user can position the pointing device within the display port 118 and then “double-click” to initiate the swapping. The swapping can be performed using a processor, such as the processor 102 shown in FIG. 1. In a related embodiment, an input focus can be associated with the window when swapping the information presented in the display port with the information presented in the window. The second process can receive information from a user interface when the input focus is associated with the window.

According to another exemplary embodiment, the presenting of information related to the second process and the display port can be hidden while maintaining an execution of the second process. For example, the hiding of the display port 118, shown in FIG. 4, and information related to the second process “Process 2” can occur in response to a user activating a control button 404 included in the window 402. The result of the hiding of the display port 118 can be as shown in the window 406. The hiding of the display port 118 can also occur when hiding the presenting of information related to the first process “Process 1” and the window 402 shown in the figure. The hiding of the window 402 can occur while maintaining an execution of the first process “Process 1”.

In yet another exemplary embodiment, the display port can be closed and an execution of the second process can be halted. As described above in conjunction with FIG. 4, a closing of the display port 118 included in the window 402 can be initiated by positioning the pointing device 114 over the display port 118, and then performing an action, such as pressing the “CTRL” key on the keyboard 112 while “clicking” a button on the pointing device 114. Logic included in the processor 102 can then close the display port 118 and halt the execution of the second process “Process 2”. Results of closing the display port 118 can be presented as shown in the window 406. When no display ports 118 are active in the window (hidden or otherwise), the control button 404 can be presented as inactive, such as the “grayed-out” control button 410 shown in the figure.

The display port can also be closed while maintaining an execution of the second process. For example, this can occur in response to a closing of the window 402, shown in FIG. 4, and a halting of an execution of the first process “Process 1”. A user may desire that the second process “Process 2” continue to execute and be monitored after the window 402 is closed. Accordingly, a second window (not shown) can be opened that is resizable within the presentation space 106 of the monitor 104. Information related to the second process “Process 2” can then be presented in the second window (not shown).

As shown in FIG. 2, the second process can be added to a list of selected processes. The list of selected processes can be included as selectable entries in a drop-down menu associated with the window, such as the drop-down menu 208 shown in the figure. The selecting of the second process can include browsing a repository of available processes including the second process. The browsing can be initiated by selecting an entry in the drop-down menu 208 shown in FIG. 2, such as the “Browse . . . ” entry.

The executable instructions of a computer program as illustrated in FIG. 6 for exchanging information with a process using a window display port can be embodied in any computer readable medium for use by or in connection with an instruction execution system, apparatus, or device, such as a computer based system, processor containing system, or other system that can fetch the instructions from the instruction execution system, apparatus, or device and execute the instructions.

As used here, a “computer readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium, such as the removable storage device 116 shown in FIG. 1. More specific examples (a non exhaustive list) of the computer readable medium can include the following: an electrical connection having one or more wires, a portable computer diskette, a random access memory (RAM), a read only memory (ROM), an erasable programmable read only memory (EPROM or Flash memory), an optical fiber, and a portable compact disc read only memory (CDROM).

It will be appreciated by those of ordinary skill in the art that the concepts and techniques described here can be embodied in various specific forms without departing from the essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

1. A method for exchanging information with a process using a window display port, the method comprising:
presenting information related to a first process in a window that is resizable within a presentation space of a monitor;
selecting a second process;
opening a display port in a portion of the window;
presenting information related to the second process in the display port; and
linking the display port to the window within the presentation space of the monitor.

2. The method of claim 1, comprising:
associating an input focus with the window, wherein the first process can receive information from a user interface; and
associating the input focus with the display port, wherein the second process can receive information from the user interface.

3. The method of claim 2, comprising:
associating the input focus with only one of the window and the display port at a time.

4. The method of claim 3, comprising:
switching the input focus between the window and the display port.

5. The method of claim 3, comprising:
switching the input focus to the display port when opening the display port in the portion of the window.

6. The method of claim 1, comprising:
swapping the information presented in the display port related to the second process with the information presented in the window related to the first process.

7. The method of claim 6, comprising:
associating an input focus with the window when swapping the information presented in the display port with the information presented in the window, wherein the second process can receive information from a user interface.

8. The method of claim 1, comprising:
hiding the presenting of information related to the second process and the display port while maintaining an execution of the second process.

9. The method of claim 8, wherein the hiding occurs when hiding the presenting of information related to the first process and the window while maintaining an execution of the first process.

10. The method of claim 1, comprising:
closing the display port; and
halting an execution of the second process.

11. The method of claim 1, comprising:
closing the display port while maintaining an execution of the second process when closing the window and halting an execution of the first process;
opening a second window that is resizable within the presentation space of the monitor; and
presenting information related to the second process in the second window.

12. The method of claim 1, comprising:
adding the second process to a list of selected processes; and
including the list of selected processes as selectable entries in a drop-down menu associated with the window.

13. The method of claim 1, wherein the selecting comprises:
browsing a repository of available processes including the second process.

14. The method of claim 1, wherein the linking comprises:
resizing the display port an amount proportional to an amount the window changes when the window is resized.

15. The method of claim 1, wherein the linking comprises:
maintaining a relative positioning of the display port within the window when repositioning the window within the presentation space of the monitor.

16. The method of claim 1, wherein the first and second processes are associated with respective application programs.

17. A system for exchanging information with a process using a window display port, the system comprising:
a monitor having a presentation space; and
a processor operatively coupled to the monitor, the processor including:
logic configured to present information related to a first process in a window that is resizable within a presentation space of a monitor;
logic configured to select a second process;
logic configured to open a display port in a portion of the window;
logic configured to present information related to the second process in the display port; and
logic configured to link the display port to the window within the presentation space of the monitor.

18. The system of claim 17, comprising:
a user interface operatively coupled to the processor;
wherein the processor includes:
logic configured to associate an input focus with the window, wherein the first process can receive information from the user interface; and
logic configured to associate the input focus with the display port, wherein the second process can receive information from the user interface.

19. The system of claim 18, wherein the processor comprises:
logic configured to associate the input focus with only one of the window and the display port at a time.

20. The system of claim 19, wherein the processor comprises:
logic configured to switch the input focus between the window and the display port.

21. The system of claim 19, wherein the processor comprises:
logic configured to switch the input focus to the display port when opening the display port in the portion of the window.

22. The system of claim 17, wherein the processor comprises:
logic configured to swap the information presented in the display port related to the second process with the information presented in the window related to the first process.

23. The system of claim 22, wherein the processor comprises:
logic configured to associate an input focus with the window when swapping the information presented in the display port with the information presented in the window, wherein the second process can receive information from a user interface.

24. The system of claim 23, wherein the logic configured to swap the information is responsive to an output of a pointing device included in the user interface.

25. The system of claim 17, wherein the processor comprises:
logic configured to hide the presenting of information related to the second process and the display port while maintaining an execution of the second process.

26. The system of claim 25, wherein the logic configured to hide is responsive to an activation of a control button associated with the window.

27. The system of claim 25, wherein the logic configured to hide is responsive to a hiding of the presenting of information related to the first process and the window while maintaining an execution of the first process.

28. The system of claim 17, wherein the processor comprises:
logic configured to close the display port; and
logic configured to halt an execution of the second process.

29. The system of claim 28, wherein the logic configured to close the display port is responsive to a combined output of a keyboard and a pointing device included in a user interface.

30. The system of claim 17, wherein the processor comprises:
logic configured to close the display port while maintaining an execution of the second process;
logic configured to open a second window that is resizable within the presentation space of the monitor; and
logic configured to present information related to the second process in the second window.

31. The system of claim 30, wherein the logic configured to close the display port is responsive to a closing of the window and a halting of an execution of the first process.

32. The system of claim 17, wherein the processor comprises:
logic configured to add the second process to a list of selected processes; and
logic configured to include the list of selected processes as selectable entries in a drop-down menu associated with the window.

33. The system of claim 32, wherein the logic configured to select comprises:
logic configured to browse a repository of available processes including the second process.

34. The system of claim 33, wherein the logic configured to browse is responsive to a selection of an entry in the drop-down menu.

35. The system of claim 17, wherein the logic configured to link comprises:
logic configured to resize the display port an amount proportional to an amount the window changes when the window is resized.

36. The system of claim 17, wherein the logic configured to link comprises:
logic configured to maintain a relative positioning of the display port within the window when repositioning the window within the presentation space of the monitor.

37. The system of claim 17, wherein the first and second processes are associated with respective application programs that can be executed using the processor.

38. A computer readable medium containing a computer program for exchanging information with a process using a window display port, wherein the computer program comprises executable instructions for:
presenting information related to a first process in a window that is resizable within a presentation space of a monitor;
selecting a second process;
opening a display port in a portion of the window;
presenting information related to the second process in the display port; and
linking the display port to the window within the presentation space of the monitor.

39. The computer readable medium claim 38, wherein the computer program comprises executable instructions for:
associating an input focus with the window, wherein the first process can receive information from a user interface; and
associating the input focus with the display port, wherein the second process can receive information from the user interface.

40. The computer readable medium claim 38, wherein the computer program comprises executable instructions for:
swapping the information presented in the display port related to the second process with the information presented in the window related to the first process.

41. The computer readable medium claim 40, wherein the computer program comprises executable instructions for:
associating an input focus with the window when swapping the information presented in the display port with the information presented in the window, wherein the second process can receive information from a user interface.

42. The computer readable medium claim 38, wherein the computer program comprises executable instructions for:
hiding the presenting of information related to the second process and the display port while maintaining an execution of the second process.

43. The computer readable medium claim 38, wherein the computer program comprises executable instructions for:
adding the second process to a list of selected processes; and
including the list of selected processes as selectable entries in a drop-down menu associated with the window.

44. The computer readable medium claim 38, wherein in linking, the computer program comprises executable instructions for:
maintaining a relative positioning of the display port within the window when repositioning the window within the presentation space of the monitor.

45. A system for exchanging information with a process using a window display port, the system comprising:
a monitor having a presentation space;
means for presenting information related to a first process in a window that is resizable within the presentation space of the monitor;
means for selecting a second process;
means for opening a display port in a portion of the window;
means for presenting information related to the second process in the display port; and
means for linking the display port to the window within the presentation space of the monitor.

46. The system of claim 45, comprising:
means for associating an input focus with the window, wherein the first process can receive information from a user interface; and
means for associating the input focus with the display port, wherein the second process can receive information from the user interface.

47. The system of claim 45, comprising:
means for swapping the information presented in the display port related to the second process with the information presented in the window related to the first process.

48. The system of claim 47, comprising:
means for associating an input focus with the window when swapping the information presented in the display port with the information presented in the window, wherein the second process can receive information from a user interface.

49. The system of claim 45, comprising:
means for hiding the presenting of information related to the second process and the display port while maintaining an execution of the second process.

50. The system of claim 45, comprising:
means for maintaining a relative positioning of the display port within the window when repositioning the window within the presentation space of the monitor.
